(19) United States
(12) Patent Application Publication
(10) Pub. No.: US 2026/0080604 A1
(43) Pub. Date: Mar. 19, 2026

(54) Dependency Controls for Mid-Render Compute Shaders on a Graphics Processor

(71) Applicant: Apple Inc., Cupertino, CA (US)

(72) Inventors: Justin A. Hensley, Mountain View, CA (US); Jeffrey T. Brady, Orlando, FL (US); Michael Imbrogno, Morgan Hill, CA (US)

(21) Appl. No.: 18/975,855

(22) Filed: Dec. 10, 2024

Related U.S. Application Data
(60) Provisional application No. 63/696,570, filed on Sep. 19, 2024.

(51) Int. Cl. G06T 15/00; G06T 15/40

(52) U.S. Cl. CPC G06T 15/005; G06T 15/405

(57) ABSTRACT

Techniques are disclosed relating to graphics processors and compute shader programs. Rasterization circuitry may generate fragment data based on geometry data associated with vertex shaders. It may buffer in received order for at least a portion of a graphics frame: the geometry data, corresponding generated fragment data, and mid-render compute command data. It may perform one or more tests to potentially cull buffered geometry data such that it is no longer valid for subsequent processing. Control circuitry may determine whether to initiate mid-render compute shaders programs on the shader circuitry in response to buffered mid-render compute commands based on condition information associated with the mid-render compute commands. For example, if may initiate a first compute shader with a first corresponding condition only if at least some geometry data, that was buffered before a first mid-render compute command, remains valid after the one or more tests.

The present application claims priority to U.S. Provisional App. No. 63/696,570, entitled “Dependency Controls for Mid-Render Compute Shaders on a Graphics Processor,” filed September 19, 2024, the disclosure of which is incorporated by reference herein in its entirety.

### BACKGROUND

### Technical Field

This disclosure relates generally to graphics processors and more particularly to controlling compute shader programs.

### Description of Related Art

Graphics processors execute various types of shader programs, e.g., vertex shaders, fragment shaders, and compute shaders. Graphics processors may also include fixed-function circuitry configured to perform various operations in conjunction with shaders.

U.S. Pat. No. 10,223,822 issued March 5, 2019 and titled “Mid-Render Compute for Graphics Processing” discusses techniques for executing a compute shader in the middle of a graphics render. The ’822 patent also discusses how this may reduce memory traffic and techniques for using local memory to share data between compute tasks and fragment shaders.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating example conditional mid-render compute techniques in the context of a shader core and rasterization circuitry, according to some embodiments.

FIG. 3 is a diagram illustrating example categories of conditions for mid-render compute, according to some embodiments.

FIG. 4 is a flow diagram illustrating a detailed example method for determining whether to run mid-render compute shaders, according to some embodiments.

FIG. 5 is a diagram illustrating example buffer states and corresponding decisions for different mid-render compute conditions, according to some embodiments.

FIG. 6 is a flow diagram illustrating an example method, according to some embodiments.

FIG. 7 is a block diagram illustrating an example computing device, according to some embodiments.

FIG. 8 is a diagram illustrating example applications of disclosed systems and devices, according to some embodiments.

FIG. 9 is a block diagram illustrating an example computer-readable medium that stores circuit design information, according to some embodiments.

### DETAILED DESCRIPTION

In disclosed embodiments, control circuitry conditionally determines whether to run compute threads mid-render, which is referred to as conditional mid-render compute (MRC). Conditional mid-render compute kernels may be buffered by rasterization circuitry along with geometry data, fragment data, or both. Various tests may be performed on buffered data, e.g., depth and stencil tests that may cull some of the buffered data such that it no longer valid for further processing. Mid-render compute kernels may be conditionally executed based on the status of other buffered data (e.g., they may run only if prior geometry survived or run only if subsequent geometry survived, depending on the condition). Control circuitry may also support unconditional mid-render compute kernels and bounds on which portion of the buffer is examined for surviving geometry (these bounds may be implemented using dependency-reset commands, for example).

Conditional mid-render compute may advantageously improve performance, reduce power consumption, or both, e.g., by allowing mid-render compute operations to be performed for only certain portions of a graphics frame. This may be particularly advantageous for rendering techniques that handle different portions (e.g., tiles) of a graphics frame differently, e.g., based on eye tracking, partial frame updates, etc.

As discussed in detail below, conditional mid-render compute techniques may provide advantages for various graphics processing techniques, such as local memory initialization, tile analysis, re-initialization, full-screen rendering, etc.

### Graphics processing overview

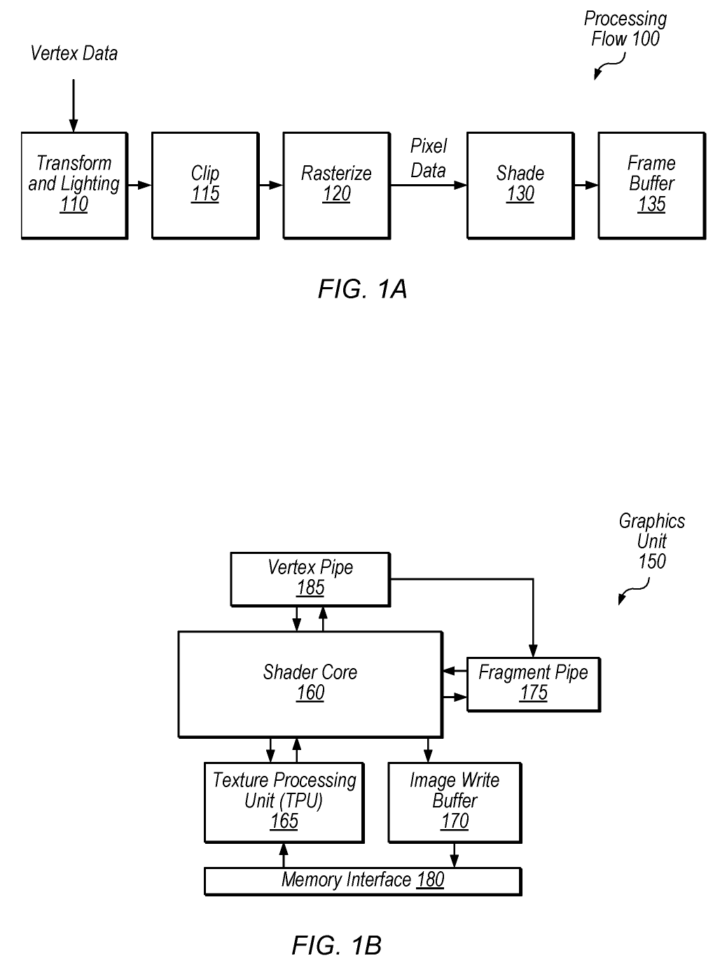

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include shader cores that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes shader core 160, vertex pipe 185, fragment pipe 175, texture processing unit (TPU) 165, image write buffer 170, and memory interface 180. In some embodiments, graphics unit 150 is configured to process both vertex and fragment data using shader core 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with shader core 160 in order to coordinate vertex processing. In the illustrated embodiment, vertex pipe 185 is configured to send processed data to fragment pipe 175 or shader core 160 for further processing.

Fragment pipe 175, in the illustrated embodiment, may include various fixed-function hardware configured to process pixel data. Fragment pipe 175 may be configured to communicate with shader core 160 in order to coordinate fragment processing. Fragment pipe 175 may be configured to perform rasterization on polygons from vertex pipe 185 or shader core 160 to generate fragment data. Vertex pipe 185 and fragment pipe 175 may be coupled to memory interface 180 (coupling not shown) in order to access graphics data.

Shader core 160, in the illustrated embodiment, is configured to receive vertex data from vertex pipe 185 and fragment data from fragment pipe 175 and TPU 165. Shader core 160 may be configured to perform vertex processing tasks on vertex data which may include various transformations and adjustments of vertex data. Shader core 160, in the illustrated embodiment, is also configured to perform fragment processing tasks on pixel data such as texturing and shading, for example. Shader core 160 may include multiple sets of multiple execution pipelines for processing data in parallel.

In some embodiments, shader core includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include shader core cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple shader cores 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from shader core 160. In some embodiments, TPU 165 is configured to pre-fetch texture data and assign initial colors to fragments for further processing by shader core 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2x2 format to be processed by a group of four execution pipelines in shader core 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

### Overview of conditional mid-render compute

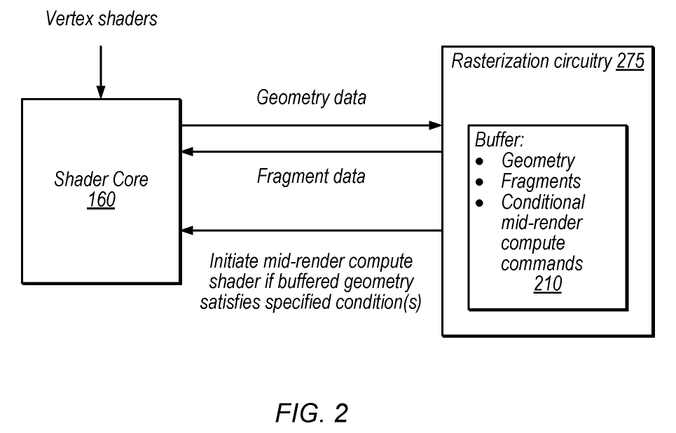

FIG. 2 is a block diagram illustrating example conditional mid-render compute techniques in the context of a shader core and rasterization circuitry, according to some embodiments. In the illustrated example, a graphics processor includes shader core 160 and rasterization circuitry 275.

Shader core 160, in some embodiments, executes vertex shaders that operate on primitive vertices. Draw commands may associate vertices with a primitive and may cause operations by rasterization circuitry 275 to generate fragment data. Shader core 160 also executes fragment shaders that operate on fragment data. As mentioned above, shader core 160 may also execute compute shaders mid-render.

Rasterization circuitry 275, in some embodiments, is configured to communicate with geometry and tiling processing portion of the graphics processor (which may perform certain transform or culling operations for a given render pass). Circuitry 275 may also be referred to as fragment generator circuitry. Rasterization circuitry 275 may perform various operations for draw commands and may maintain corresponding state information, which may persist across multiple draws. Mid-render compute control data and dependency information may be stored in this state information.

As shown, shader core 160 may provide geometry data to rasterization circuitry 275 and rasterization circuitry 275 may provide generated fragment data. This communication may be performed via a shared memory space, for example. In the illustrated example, rasterization circuitry 275 includes buffer circuitry 210 configured to buffer various information.

Buffer circuitry 210, in this example, is configured to buffer geometry data, generated fragments, and conditional mid-render compute commands. Buffer 210 may be referred to as a tag sorter. Note that while buffer 210 is shown as being included in circuitry 275, it may be located in various different locations and may or may not be accessible to other circuitry. For example, it may be a dedicated hardware buffer or may be implemented in a shared memory space and stored in a data cache. As shown, rasterization circuitry 275 may initiate mid-render compute shaders on shader core 160 if buffered geometry in buffer 210 satisfies specified conditions.

Note that mid-render compute may be initiated using various appropriate techniques. As one example, the interface between rasterization circuitry 275 and shader core 160 may support explicit launching of a given compute shader (e.g., by specifying a shader index and location of input data). As another example, mid-render compute commands may be implemented as a draw command in a control stream, e.g., with a large rectangular primitive for processing by geometry circuitry and rasterization circuit 275. This large primitive may then be treated by shader core 160 as a mid-render compute launch indication, e.g., based on its state information. Various techniques for specifying conditional mid-render compute commands in a control stream are contemplated in different control stream encoding implementations.

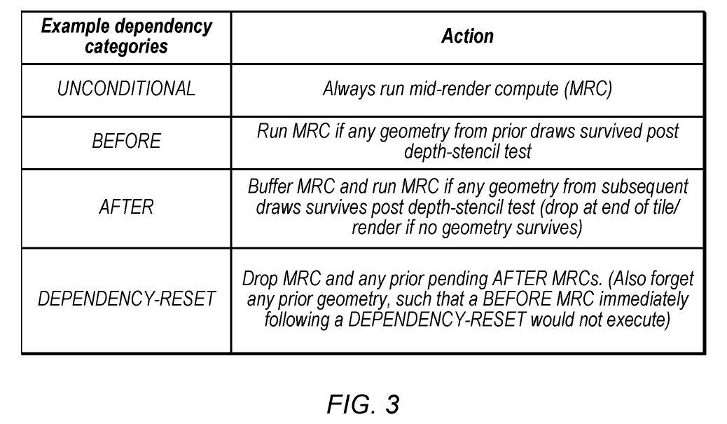

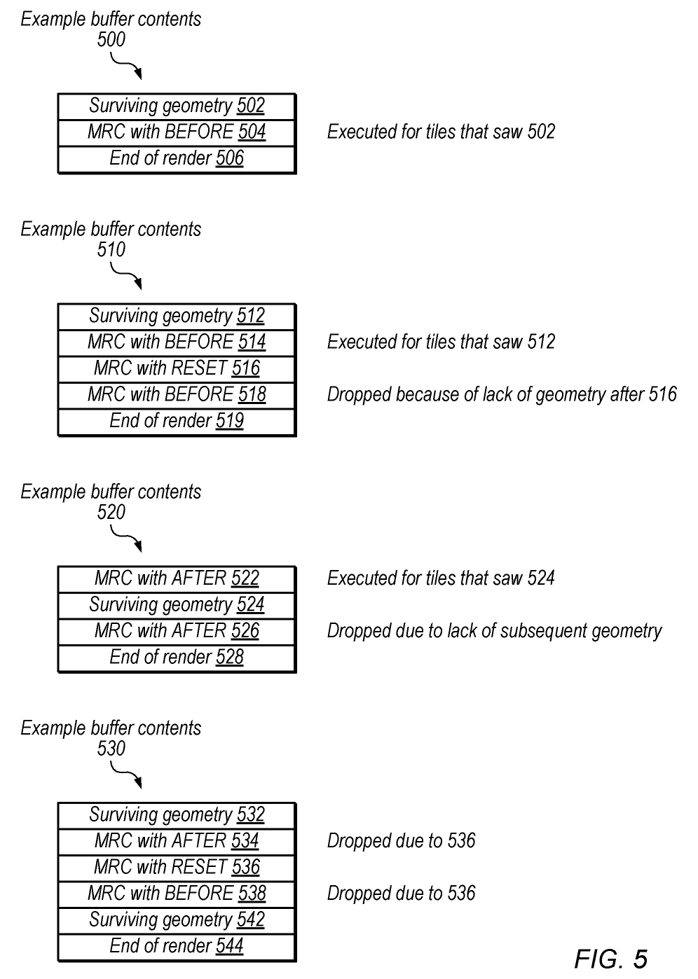

FIG. 3 is a diagram illustrating example categories of conditions for mid-render compute, according to some embodiments. In the illustrated example, the graphics processor supports four dependency categories for conditional mid-render compute commands: UNCONDITIONAL, BEFORE, AFTER, and DEPENDENCY-RESET. Note that FIG. 5, discussed in detail below, provides specific example buffer states and results for various dependency types.

A mid-render compute command with an UNCONDITIONAL dependency will always cause execution of the indicated mid-render compute kernel, in the illustrated embodiment (barring an exception, loss of power, or some other scenario that causes a program to execute or end abnormally).

A mid-render compute command with a BEFORE dependency will cause execution of the indicated mid-render compute kernel if geometry from prior draws survived one or more tests (depth and stencil tests, in this example). As discussed above, various tests may cull geometry such that it is not valid for further processing. Generally, this culling may improve performance and reduce power consumption, e.g., by avoiding processing operations for geometry determined not to be visible. Said another way, for BEFORE dependencies, the mid-render compute kernel will not run if there is no geometry in the buffer 210 (or no geometry in a specified window within the buffer) from earlier draws when the mid-render compute command is reached.

A mid-render compute command with an AFTER dependency will cause execution of the indicated mid-render compute kernel if geometry from subsequent draws survived one or more tests (depth and stencil tests, in this example). Note that a mid-render compute command with an after dependency may remain buffered until the end of a tile or end of a render (or until the end of a specified window within the buffer). At that point, if no subsequent surviving geometry has been encountered, that mid-render compute command is dropped.

A DEPENDENCY-RESET command may be used to set boundaries on BEFORE and after dependencies. In this example, a mid-render compute command with a dependency-reset dependency is always dropped, along with any prior pending mid-render compute commands with after dependencies. Therefore, the DEPENDENCY-RESET sets a boundary on the portion of the buffer that AFTER MRCs examine whether determining whether geometry survives. As shown, a mid-render compute command with a DEPENDENCY-RESET also causes control circuitry to forget any prior geometry. This sets the starting boundary for any subsequent mid-render compute commands with BEFORE dependencies. For example, an immediately following MRC with a BEFORE dependency would be dropped because no geometry survives between the DEPENDENCY-RESET and the MRC.

Note that while the dependency-reset is attached to a mid-render compute command in this example, it may be an independent command in other embodiments, given that its corresponding MRC does not actually execute. Further, in some embodiments, separate commands may be used to set boundaries for different types of dependencies (e.g., separate commands to set boundaries for BEFORE dependencies and for AFTER dependencies).

Note that buffer 210 may be arranged according to draw order, e.g., as a ring buffer, such that it maintains relative ages of data and commands in the buffer. For example, entries earlier in the buffer may correspond to commands/data from earlier draw commands in the command stream. In various embodiments, different appropriate encodings of age may be implemented, including explicit timestamps, relationships between positions in a data structure, etc. Various disclosed dependencies or conditions may be based on status of younger or older buffer entries.

The system may impose a limit on the number of buffered mid-render compute commands and may initiate pending mid-render compute commands when that limit is met, regardless of condition status. This may limit the complexity of the condition control circuitry while ensuring that MRC kernels are not unintentionally dropped.

In some embodiments, additional parameters may be specified for dependencies. For example, a condition may specify a threshold amount of before/after geometry, one or more types of surviving geometry, etc. that are examined to determine whether the condition is satisfied. These parameters may be encoded in fields of an MRC command, in other state information, etc. Such additional parameters may provide additional granularity to determine when to run conditional MRC kernels.

### Example graphics tasks that may utilize conditional mid-render compute

Disclosed techniques may be used in various contexts to conditionally execute mid-render compute kernels, e.g., on a per-render or per-tile-within-a-render basis. The following discussion covers the following four examples, although various other applications are contemplated: local memory initialization, tile analysis, re-initialization, and full-screen rendering.

Local memory may be utilized for various rendering tasks, e.g., when passing data between SIMT threads and fixed-function hardware. Software (e.g., a compute shader) may perform various operations to initialize local memory before it is ready to be used. Therefore, in some embodiments, a mid-render compute kernel that initializes local memory with an AFTER dependency runs only if there is subsequent surviving geometry. If there is no subsequent surviving geometry, then local memory need not be initialized for that tile. This may reduce power consumption by avoiding unnecessary compute shader execution and may improve performance by freeing execution resources for other shaders.

Tile analysis may generate statistics about rendering operations for a given tile, which may be useful for adjusting subsequent processing, for example. Note that latency and power consumption may be particularly important in certain applications, e.g., in wearable devices such as augmented reality or virtual reality headsets. In this context, it may be desirable to perform tile analysis only for certain tiles. Therefore, mid-render compute kernels that perform tile analysis may have BEFORE dependencies such that they only run on a given tile if geometry is rendered (or if more than a threshold amount of geometry is rendered). This may be particularly useful in implementations with foveated rendering or accumulation renders that only affect certain portions of a graphics frame.

Re-initialization may allow render work to be split into multiple sub-passes, some of which may be skipped for some tiles. This may be implemented using two MRC commands with AFTER dependencies. For example, the command stream may include a first MRC AFTER kernel that initializes a first sub-pass, followed by geometry, followed by a second MRC AFTER kernel that re-initializes for a second sub-pass, followed by geometry. The second MRC may be dropped for some tiles if the following geometry does not survive. This may provide power and performance benefits when the second MRC is not executed. Note that this re-initialization application roughly corresponds to example buffer contents 520 of FIG. 5, discussed in detail below.

Full-screen rendering may use a large primitive (e.g., to cover an entire graphics frame), to perform a render operation such as blurring the entire screen, as one example. Similar techniques may be used for large primitives that do not necessarily cover the whole screen. Generally, this may correspond to performing compute tasks in a fragment shader. In this example, similar results may be achieved using an MRC with a BEFORE dependency.

### Example detailed method and buffer states

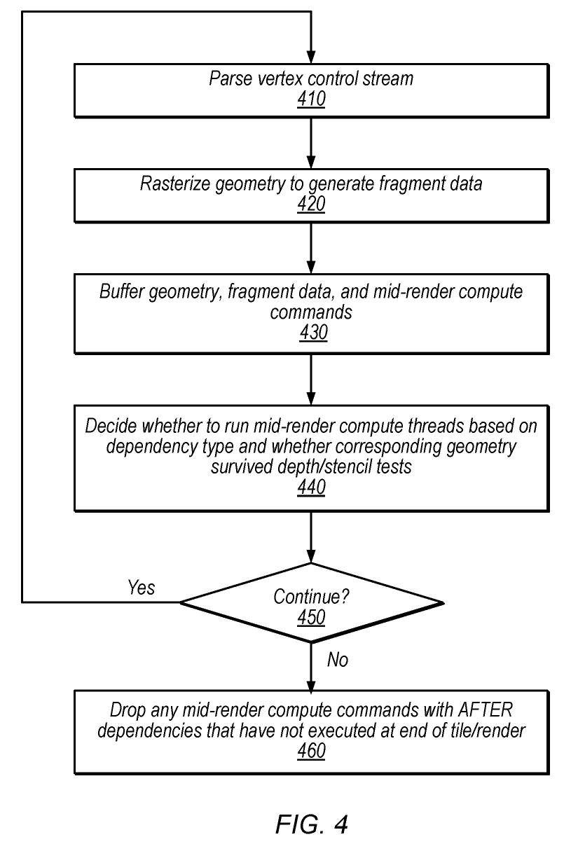

FIG. 4 is a flow diagram illustrating a detailed example method for determining whether to run mid-render compute threads. At 410, in the illustrated example, a graphics processor (e.g., vertex pipe 185) parses a vertex control stream. At 420 the processor (e.g., rasterization circuitry 275) rasterizes geometry to generate fragment data. At 430, the processor buffers geometry, fragment data, and mid-render compute commands (e.g., in buffer 210). At 440, the processor determines whether to run mid-render compute threads based on dependency type and whether corresponding geometry survived depth and stencil tests. At 450, the processor determines whether to continue parsing the vertex control stream. If parsing continues, flow proceeds back to 410,which may result in MRC AFTER dependencies being satisfied and launching one or more MRC kernels through one or more additional iterations of element 440. The parsing may continue until the end of a tile or render has been reached, for example. Once parsing is finished, flow proceeds to 460 and the processor drops any remaining mid-render compute commands with AFTER dependencies, at the end of a tile or end of a render.

Note that disclosed techniques may be implemented in graphics processors that utilize tile-based deferred rendering (TBDR) or in graphics processors of other architectures. Therefore, tile-related embodiment are included for purposes of explanation, but not intended to limit the scope of the present disclosure.

FIG. 5 is a diagram illustrating example buffer states and corresponding decisions for different mid-render compute conditions, according to some embodiments. In this example, entries toward the top of the illustrated buffer are older than entries toward the bottom of the illustrated buffer.

Example buffer contents 500 includes surviving geometry 502, MRC with BEFORE dependency 504, and an end of render command 506. In this example, the MRC 504 is executed for tiles that saw the surviving geometry 502. Note that geometry may survive for some tiles and not for others (tiles may have separate buffers 210 or a shared buffer may include tile identifier information for buffer entries). Therefore, disclosed techniques may advantageously allow different tiles to conditionally run MRC kernels or not, e.g., depending on whether the MRC operations were relevant to render of that tile.

Example buffer contents 510 includes surviving geometry 512, two MRCs with BEFORE dependencies 514 and 518, an MRC with a RESET 516, and an end of render command 519. In this example, MRC 514 is executed for tiles that have surviving geometry 512. MRC 518, however, is not executed, because the RESET at 516 sets the starting boundary for its dependency and it sees no surviving geometry.

Example buffer contents 520 includes two MRCs with AFTER dependencies 522 and 526, surviving geometry 524, and end of render command 528. In this example, MRC 522 is executed for tiles that have surviving geometry 524. MRC 526 is dropped, however, because the end of render 528 is reached before it sees any subsequent surviving geometry.

Example buffer contents 530 includes surviving geometry 532 and 542, MRC with AFTER dependency 534, MRC with RESET 536, MRC with BEFORE dependency 538, and end of render command 544. In this example, even though there is surviving geometry earlier and later in the buffer, the RESET command sets the bounds for MRC 534 and MRC 538 such that the surviving geometry does not fall within the bounds for either. Therefore, MRC 534 and MRC 538 are dropped.

### Example method

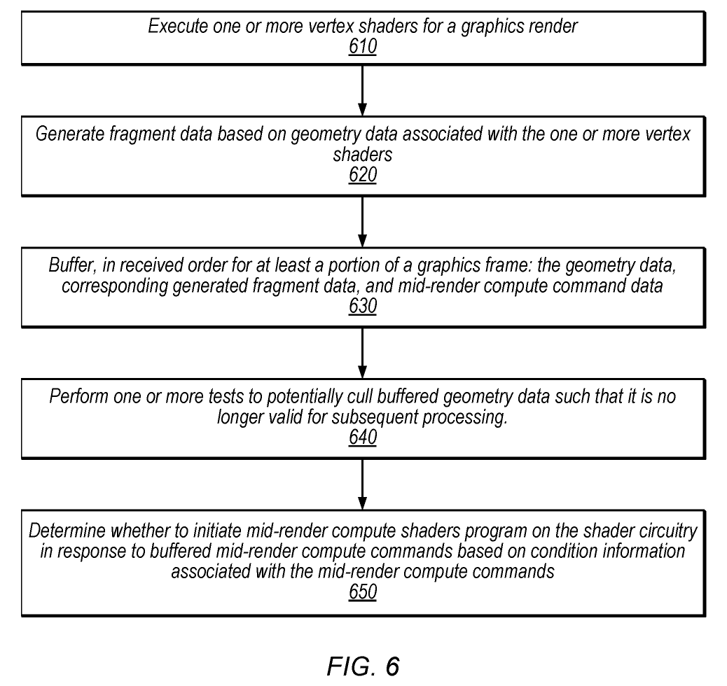

FIG. 6 is a flow diagram illustrating an example method, according to some embodiments. The method shown in FIG. 6 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 610, in the illustrated embodiment, a computing system (e.g., shader core 160) executes one or more vertex shaders for a graphics render.

At 620, in the illustrated embodiment, the computing system (e.g., rasterization circuitry 275) generates fragment data based on geometry data associated with the one or more vertex shaders.

At 630, in the illustrated embodiment, the computing system (e.g., buffer circuitry 210) buffers, in received order for at least a portion of a graphics frame: the geometry data, corresponding generated fragment data, and mid-render compute command data.

At 640, in the illustrated embodiment, the computing system (e.g., vertex pipe 185) performs one or more tests to potentially cull buffered geometry data such that it is no longer valid for subsequent processing. In some embodiments, the tests include a stencil test and a depth test.

At 650, in the illustrated embodiment, the computing system (e.g., control circuitry of rasterization circuitry 275) determines whether to initiate mid-render compute shaders programs on the shader circuitry in response to buffered mid-render compute commands based on condition information associated with the mid-render compute commands.

In some embodiments this includes initiating a first compute shader with a first corresponding condition only if at least some geometry data, that was buffered before a first mid-render compute command, remains valid after the one or more tests (e.g., for a BEFORE dependency). In some embodiments, this includes initiating a second compute shader with a second corresponding condition only if at least some geometry data, that was buffered after a second mid-render compute command, remains valid after the one or more tests (e.g., for an AFTER dependency).

In some embodiments, the system enforces conditions on mid-render compute commands on a per-tile granularity based on buffered geometry corresponding to a given tile.

In some embodiments, the computing system supports a dependency reset condition that causes the control circuitry to drop any previous pending mid-render compute commands that have an AFTER dependency and forget any prior geometry for compute command dependency purposes. In some embodiments, the system supports an unconditional condition under which it is configured to always initiate a corresponding mid-render compute command.

In some embodiments, the buffer is configured to buffer up to a threshold number of mid-render compute commands and the control circuitry is configured to initiate one or more pending mid-render compute commands, regardless of their condition status, in response to encountering a mid-render compute command when the threshold number has been met.

The second compute shader may initialize local memory for processing the buffered geometry after the second mid-render compute command. The first compute shader may perform analysis operations for a tile of a graphics frame based on the buffered geometry data before the first mid-render compute command. The second compute shader may re-initialize one or more parameters after a first sub-pass of the render, for a second sub-pass of the render that operates on the buffered geometry after the second mid-render compute command. The first compute shader may perform a full-screen render operation.

In some embodiments, the system may disable conditional mid-render compute for a set of graphics work such that all mid-render compute commands for the set of graphics work are initiated on the shader circuitry.

As used herein, the term “compute kernel” in the graphics context is intended to be interpreted according to its well-understood meaning, which includes a routine compiled for acceleration hardware such as a graphics processor. Kernels may be specified by a separate program language such as OpenCL C, may be written as compute shaders in a shading language such as OpenGL, or embedded in application code in a high level language, for example. Compute kernels typically include a number of workgroups which in turn include a number of workitems (also referred to as threads).

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction’s result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

Multiple “kicks” may be executed to render a frame of graphics data. In some embodiments, a kick is a unit of work from a single context that may include multiple threads to be executed (and may potentially include other types of graphics work that is not performed by a shader). A kick may not provide any assurances regarding memory synchronization among threads (other than specified by the threads themselves), concurrency among threads, or launch order among threads. In some embodiments, a kick may be identified as dependent on the results of another kick, which may allow memory synchronization without requiring hardware memory coherency support. Typically, graphics firmware or hardware programs configuration registers for each kick before sending the work to the pipeline for processing. Often, once a kick has started, it does not access a memory hierarchy past a certain level until the kick is finished (at which point results may be written to another level in the hierarchy). Information for a given kick may include state information, location of shader program(s) to execute, buffer information, location of texture data, available address spaces, etc. that are needed to complete the corresponding graphics operations. Graphics firmware or hardware may schedule kicks and detect an interrupt when a kick is complete, for example. In some embodiments, portions of a graphics unit are configured to work on a single kick at a time. This set of resources may be referred to as a “kickslot.” Thus, in some embodiments, any data that is needed for a given kick is read from memory that is shared among multiple processing elements at the beginning of the kick and results are written back to shared memory at the end of the kick. Therefore, other hardware may not see the results of the kick until completion of the kick, at which point the results are available in shared memory and can be accessed by other kicks (including kicks from other data masters). A kick may include a set of one or more rendering commands, which may include a command to draw procedural geometry, a command to set a shadow sampling method, a command to draw meshes, a command to retrieve a texture, a command to perform generation computation, etc. A kick may be executed at one of various stages during the rendering of a frame. Examples of rendering stages include, without limitation: camera rendering, light rendering, projection, texturing, fragment shading, etc. Kicks may be scheduled for compute work, vertex work, or pixel work, for example.

In some embodiments, a graphics driver maps a new kick to one of multiple kickslots. Each kickslot may include a set of configuration registers and may have a context ID that indicates a mapping between the kick’s virtual addresses and physical addresses. In some embodiments, the graphics driver starts a persistent mapping thread for each kickslot via a configuration register, and starts the persistent mapping thread prior to starting the kick via a configuration register. In some embodiments, a mapping thread may persist across multiple kicks in a kickslot, e.g., if the kicks have the same context ID.

### Example device

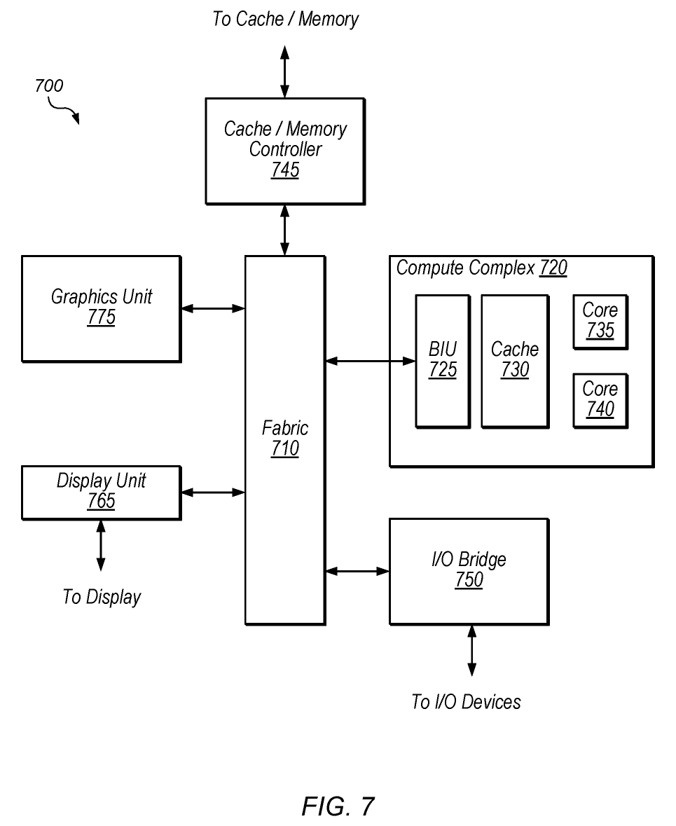

Referring now to FIG. 7, a block diagram illustrating an example embodiment of a device 700 is shown. In some embodiments, elements of device 700 may be included within a system on a chip. In some embodiments, device 700 may be included in a mobile device, which may be battery-powered. Therefore, power consumption by device 700 may be an important design consideration. In the illustrated embodiment, device 700 includes fabric 710, compute complex 720 input/output (I/O) bridge 750, cache/memory controller 745, graphics unit 775, and display unit 765. In some embodiments, device 700 may include other components (not shown) in addition to or in place of the illustrated components, such as video processor encoders and decoders, image processing or recognition elements, computer vision elements, etc.

Fabric 710 may include various interconnects, buses, MUX’s, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and caches. For example, compute complex 720 may include 1, 2, or 4 processor cores, or any other suitable number. In one embodiment, cache 730 is a set associative L2 cache. In some embodiments, cores 735 and 740 may include internal instruction and data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions. These instructions may be stored in computer readable medium such as a memory coupled to memory controller 745 discussed below.

As used herein, the term “coupled to” may indicate one or more connections between elements, and a coupling may include intervening elements. For example, in FIG. 7, graphics unit 775 may be described as “coupled to” a memory through fabric 710 and cache/memory controller 745. In contrast, in the illustrated embodiment of FIG. 7, graphics unit 775 is “directly coupled” to fabric 710 because there are no intervening elements.

Cache/memory controller 745 may be configured to manage transfer of data between fabric 710 and one or more caches and memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches. Memory coupled to controller 745 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 745 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 720 to cause the computing device to perform functionality described herein.

Graphics unit 775 may include one or more processors, e.g., one or more graphics processing units (GPUs). Graphics unit 775 may receive graphics-oriented instructions, such as OPENGL®, Metal®, or DIRECT3D® instructions, for example. Graphics unit 775 may execute specialized GPU instructions or perform other operations based on the received graphics-oriented instructions. Graphics unit 775 may generally be configured to process large blocks of data in parallel and may build images in a frame buffer for output to a display, which may be included in the device or may be a separate device. Graphics unit 775 may include transform, lighting, triangle, and rendering engines in one or more graphics processing pipelines. Graphics unit 775 may output pixel information for display images. Graphics unit 775, in various embodiments, may include shader core circuitry which may include highly parallel execution cores configured to execute graphics programs, which may include pixel tasks, vertex tasks, and compute tasks (which may or may not be graphics-related).

In some embodiments, graphics unit 775 implements disclosed conditional MRC techniques.

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and low-power always-on functionality, for example. I/O bridge 750 may also include interfaces such as pulse-width modulation (PWM), general-purpose input/output (GPIO), serial peripheral interface (SPI), and inter-integrated circuit (I2C), for example. Various types of peripherals and devices may be coupled to device 700 via I/O bridge 750.

In some embodiments, device 700 includes network interface circuitry (not explicitly shown), which may be connected to fabric 710 or I/O bridge 750. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 700 with connectivity to various types of other devices and networks.

### Example applications

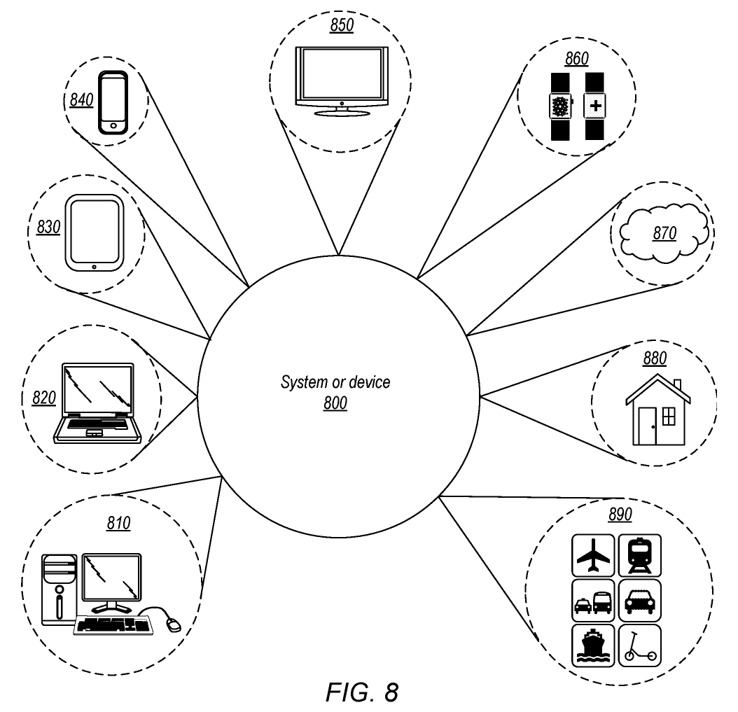

Turning now to FIG. 8, various types of systems that may include any of the circuits, devices, or system discussed above. System or device 800, which may incorporate or otherwise utilize one or more of the techniques described herein, may be utilized in a wide range of areas. For example, system or device 800 may be utilized as part of the hardware of systems such as a desktop computer 810, laptop computer 820, tablet computer 830, cellular or mobile phone 840, or television 850 (or set-top box coupled to a television).

Similarly, disclosed elements may be utilized in a wearable device 860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user’s vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 800 may also be used in various other contexts. For example, system or device 800 may be utilized in the context of a server computer system, such as a dedicated server or on shared hardware that implements a cloud-based service 870. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 800 could be employed in the control systems, guidance systems, entertainment systems, etc. of various types of vehicles 890.

The applications illustrated in FIG. 8 are merely exemplary and are not intended to limit the potential future applications of disclosed systems or devices. Other example applications include, without limitation: portable gaming devices, music players, data storage devices, unmanned aerial vehicles, etc.

### Example computer-readable medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

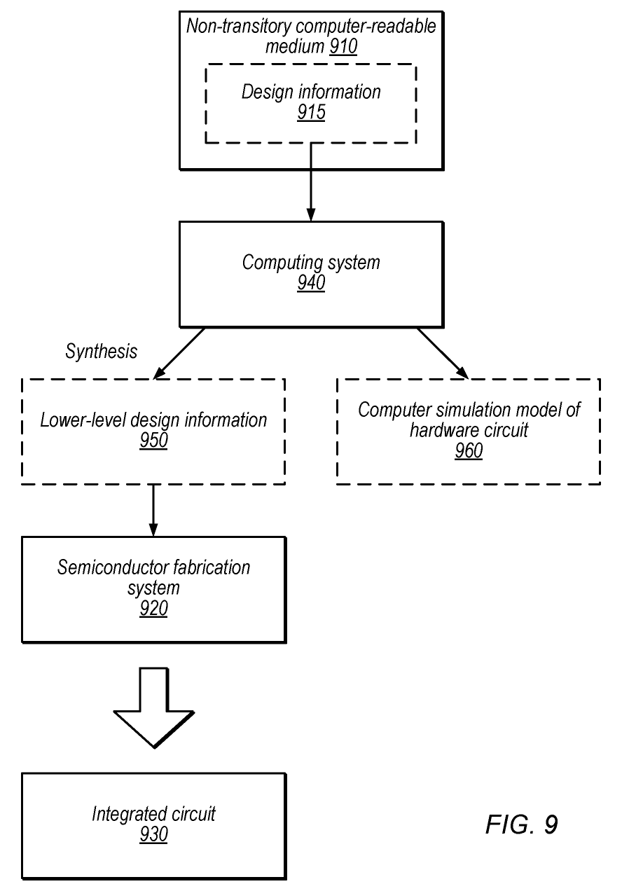

FIG. 9 is a block diagram illustrating an example non-transitory computer-readable storage medium that stores circuit design information, according to some embodiments. In the illustrated embodiment, computing system 940 is configured to process the design information. This may include executing instructions included in the design information, interpreting instructions included in the design information, compiling, transforming, or otherwise updating the design information, etc. Therefore, the design information controls computing system 940 (e.g., by programming computing system 940) to perform various operations discussed below, in some embodiments.

In the illustrated example, computing system 940 processes the design information to generate both a computer simulation model of a hardware circuit 960 and lower-level design information 950. In other embodiments, computing system 940 may generate only one of these outputs, may generate other outputs based on the design information, or both. Regarding the computing simulation, computing system 940 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 940 also processes the design information to generate lower-level design information 950 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 950 (potentially among other inputs), semiconductor fabrication system 920 is configured to fabricate an integrated circuit 930 (which may correspond to functionality of the simulation model 960). Note that computing system 940 may generate different simulation models based on design information at various levels of description, including information 950, 915, and so on. The data representing design information 950 and model 960 may be stored on medium 910 or on one or more other media.

In some embodiments, the lower-level design information 950 controls (e.g., programs) the semiconductor fabrication system 920 to fabricate the integrated circuit 930. Thus, when processed by the fabrication system, the design information may program the fabrication system to fabricate a circuit that includes various circuitry disclosed herein.

Non-transitory computer-readable storage medium 910, may comprise any of various appropriate types of memory devices or storage devices. Non-transitory computer-readable storage medium 910 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 910 may include other types of non-transitory memory as well or combinations thereof. Accordingly, non-transitory computer-readable storage medium 910 may include two or more memory media; such media may reside in different locations—for example, in different computer systems that are connected over a network.

Design information 915 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 940, semiconductor fabrication system 920, or both. In some embodiments, design information may also include one or more cell libraries that specify the synthesis, layout, or both of integrated circuit 930. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 930 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 920 may also be configured to perform various testing of fabricated circuits for correct operation.

In various embodiments, integrated circuit 930 and model 960 are configured to operate according to a circuit design specified by design information 915, which may include performing any of the functionality described herein. For example, integrated circuit 930 may include any of various elements shown in FIGS. 1B, 2, and 7 Further, integrated circuit 930 may be configured to perform various functions described herein in conjunction with other components. Further, the functionality described herein may be performed by multiple connected integrated circuits.

As used herein, a phrase of the form “design information that specifies a design of a circuit configured to …” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 920 to fabricate integrated circuit 930.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of … w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of … w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
graphics processor circuitry that includes:
shader circuitry configured to execute one or more vertex shaders for a graphics render;
rasterization circuitry configured to:
generate fragment data based on geometry data associated with the one or more vertex shaders;
buffer, in received order for at least a portion of a graphics frame: the geometry data, corresponding generated fragment data, and mid-render compute command data; and
perform one or more tests to potentially cull buffered geometry data such that it is no longer valid for subsequent processing; and
control circuitry configured to determine whether to initiate mid-render compute shaders programs on the shader circuitry in response to buffered mid-render compute commands based on condition information associated with the mid-render compute commands, including to:
determine to initiate a first compute shader with a first corresponding condition only if at least some geometry data, that was buffered before a first mid-render compute command, remains valid after the one or more tests; and
determine to initiate a second compute shader with a second corresponding condition only if at least some geometry data, that was buffered after a second mid-render compute command, remains valid after the one or more tests.

2. The apparatus of claim 1, wherein the control circuitry further supports a dependency reset condition that causes the control circuitry to drop any previous pending mid-render compute commands that have an after dependency and forget any prior geometry for compute command dependency purposes.

3. The apparatus of claim 1, wherein the control circuitry further supports an unconditional condition under which it is configured to always initiate a corresponding mid-render compute command.

4. The apparatus of claim 1, wherein the one or more tests include a stencil test and a depth test.

5. The apparatus of claim 1, wherein the control circuitry is configured to enforce conditions on mid-render compute commands on a per-tile granularity based on buffered geometry corresponding to a given tile.

6. The apparatus of claim 1, wherein the buffer is configured to buffer up to a threshold number of mid-render compute commands and the control circuitry is configured to initiate one or more pending mid-render compute commands, regardless of their condition status, in response to encountering a mid-render compute command when the threshold number has been met.

7. The apparatus of claim 1, wherein the second compute shader is configured to initialize local memory for processing the buffered geometry after the second mid-render compute command.

8. The apparatus of claim 1, wherein the first compute shader is configured to perform analysis operations for a tile of a graphics frame based on the buffered geometry data before the first mid-render compute command.

9. The apparatus of claim 1, wherein the second compute shader is configured to re-initialize one or more parameters after a first sub-pass of the render, for a second sub-pass of the render that operates on the buffered geometry after the second mid-render compute command.

10. The apparatus of claim 1, wherein the first compute shader is configured to perform a full-screen render operation.

11. The apparatus of claim 1, wherein the control circuitry is configured to disable conditional mid-render compute for a set of graphics work such that all mid-render compute commands for the set of graphics work are initiated on the shader circuitry.

12. The apparatus of claim 1, wherein the apparatus is a computing device that further includes:
a central processing unit;
a display; and
network interface circuitry.

13. A method, comprising:
executing, by a computing system, one or more vertex shaders for a graphics render;
generating, by the computing system, fragment data based on geometry data associated with the one or more vertex shaders;
buffering, by the computing system, in received order for at least a portion of a graphics frame: the geometry data, corresponding generated fragment data, and mid-render compute command data;
performing, by the computing system, one or more tests that cull a portion of buffered geometry data such that it is no longer valid for subsequent processing; and
determining, by the computing system, whether to initiate mid-render compute shaders programs in response to buffered mid-render compute commands based on condition information associated with the mid-render compute commands.

14. The method of claim 13, wherein the determining includes initiating a first compute shader with a first corresponding condition only in response to determining that at least some geometry data, that was buffered before a first mid-render compute command, remains valid after the one or more tests.

15. The method of claim 14, wherein the determining includes initiating a second compute shader with a second corresponding condition only in response to determining that at least some geometry data, that was buffered after a second mid-render compute command, remains valid after the one or more tests.

16. The method of claim 13, further comprising performing a command with a dependency reset to drop any previous pending mid-render compute commands that have an after dependency and forget any prior geometry for compute command dependency purposes.

17. The method of claim 13, further comprising:
enforcing by the computing system, conditions on mid-render compute commands on a per-tile granularity based on buffered geometry corresponding to a given tile.

18. A non-transitory computer-readable medium having instructions of a hardware description programming language stored thereon that, when processed by a computing system, program the computing system to generate a computer simulation model, wherein the model represents a hardware circuit that includes:
graphics processor circuitry that includes:
shader circuitry configured to execute one or more vertex shaders for a graphics render;
rasterization circuitry configured to:
generate fragment data based on geometry data associated with the one or more vertex shaders;
buffer, in received order for at least a portion of a graphics frame: the geometry data, corresponding generated fragment data, and mid-render compute command data; and
perform one or more tests to potentially cull buffered geometry data such that it is no longer valid for subsequent processing; and
control circuitry configured to determine whether to initiate mid-render compute shaders programs on the shader circuitry in response to buffered mid-render compute commands based on condition information associated with the mid-render compute commands, including to:
determine to initiate a first compute shader with a first corresponding condition only if at least some geometry data, that was buffered before a first mid-render compute command, remains valid after the one or more tests; and
determine to initiate a second compute shader with a second corresponding condition only if at least some geometry data, that was buffered after a second mid-render compute command, remains valid after the one or more tests.

19. The non-transitory computer-readable medium of claim 18, wherein the control circuitry further supports a dependency reset condition that causes the control circuitry to drop any previous pending mid-render compute commands that have an after dependency and forget any prior geometry for compute command dependency purposes.

20. The non-transitory computer-readable medium of claim 18, wherein the control circuitry is configured to enforce conditions on mid-render compute commands on a per-tile granularity based on buffered geometry corresponding to a given tile.
